(19) United States
(12) Patent Application Publication
(10) Pub. No.: US 2009/0294231 A1
(43) Pub. Date: Dec. 3, 2009

(54) Magneto-rheological fluid damper having enhanced on-state yield strength

(75) Inventors: J. David Carlson, Cary, NC (US); Mark R. Jolly, Raleigh, NC (US); Douglas E. Ivers, Cary, NC (US)

Correspondence Address: LORD CORPORATION;PATENT & LEGAL SERVICES, 111 LORD DRIVE, P.O. Box 8012, CARY, NC, 27512-8012, US

(73) Assignee: LORD CORPORATION, Cary, NC (US)

(21) Appl. No.: 12/477,101

(22) Filed: Jun. 2, 2009

Related U.S. Application Data
(60) Provisional application No. 61/058,203, filed on Jun. 2, 2008.

(51) Int. Cl. F16F 9/53; F15C 4/00; B23P 11/00

(52) U.S. Cl. 188/267.2; 137/807; 137/827; 29/428

(57) ABSTRACT

Please replace the Abstract with the following amended Abstract: A magneto-rheological fluid valve includes a magnetic field generator having at least one electromagnetic coil and at least one magnetic pole having a pole length Lₘ. The magneto-rheological fluid valve further includes at least one flow channel adjacent to the magnetic field generator. The at least one flow channel has a gap width g, wherein the ratio Lₘ/g is greater than or equal to 15.

### CROSS-REFERENCE TO RELATED APPLICATIONS

This application claims benefit of Provisional Application No. 61/058,203, filed Jun. 2, 2008, the disclosure of which is incorporated herein by reference.

### FIELD

The invention relates generally to the field of controllable fluid valves and devices. More specifically, the invention relates to controllable magneto-rheological fluid damper devices.

### BACKGROUND

A magneto-rheological (MR) fluid damper device typically includes a cylinder containing an MR fluid and a piston assembly arranged for reciprocating motion within the cylinder. The piston assembly defines two chambers within the cylinder and includes an MR fluid valve device for controlling flow of MR fluid between the two chambers. The MR fluid valve device typically includes a flow channel open to the MR fluid in the two chambers and a magnetic field generator for applying a magnetic field to the MR fluid in the flow channel. When the MR fluid in the flow channel is exposed to the applied magnetic field, the apparent viscosity of the MR fluid increases, leading to an increase in the pressure differential across the piston assembly, also recognized as an increase in damper force. The pressure differential or damper force increases as the strength of the magnetic field increases. The MR fluid damper device is said to be at the on-state when magnetic field is applied to the MR fluid in the flow channel and at off-state when magnetic field is not applied to the MR fluid in the flow channel.

There is a need for an MR fluid damper device that exhibits a low damper force at off-state while achieving a higher damper force at on-state, particularly when the damper device operates at high damper velocities.

### SUMMARY

In an embodiment the invention includes a magneto-rheological fluid valve. The magneto-rheological fluid valve preferably includes a magnetic field generator having at least one electromagnetic coil and at least one magnetic pole having a pole length Lₘ. The magneto-rheological fluid valve preferably includes at least one flow channel adjacent to the electromagnetic coil, where the at least one flow channel has a gap width g, and the ratio Lₘ/g is preferably greater than or equal to 15.

In an additional embodiment the invention includes a magneto-rheological fluid damper. The magneto-rheological fluid damper preferably includes a damper housing having an internal cavity for containing a magneto-rheological fluid. The magneto-rheological fluid damper preferably includes a piston assembly dividing the damper housing internal cavity into a first damper housing internal cavity chamber and a second damper housing internal cavity chamber. The piston assembly preferably includes a magneto-rheological fluid valve with a magnetic field generator having at least a first magnetic pole, the at least first magnetic pole having a pole length Lₘ, and at least a first flow channel adjacent to the magnetic field generator, the at least first flow channel having a gap width g, wherein the ratio Lₘ/g is preferably greater than or equal to 15. The damper housing internal cavity is preferably provided with a magneto-rheological damper fluid having a magneto-rheological fluid magnetic iron particles total volume percentage below 30%, wherein the magneto-rheological damper fluid having a magneto-rheological fluid magnetic iron particles total volume percentage below 30% controllably flows through the at least a first flow channel with the preferred ratio of Lₘ/g to control a motion of the piston assembly relative to the damper housing.

In an additional embodiment the invention includes a magneto-rheological fluid damper. The magneto-rheological fluid damper preferably includes a damper housing having an internal cavity for containing a magneto-rheological fluid. The magneto-rheological fluid damper preferably includes a piston assembly disposed within the damper housing. The piston assembly preferably includes a magneto-rheological fluid valve comprising a magnetic field generator having at least one electromagnetic coil and at least one magnetic pole having a pole length Lₘ and at least one flow channel adjacent to the at least one electromagnetic coil, where the at least one flow channel has a gap width g, and the ratio Lₘ/g is preferably greater than or equal to 15.

In an additional embodiment the invention includes a method of making a magneto-rheological fluid damper. The method of making a magneto-rheological fluid damper preferably includes providing a damper housing having an internal cavity for containing a magneto-rheological fluid. The method of making a magneto-rheological fluid damper preferably includes providing a piston assembly for dividing the damper housing internal cavity into a first damper housing internal cavity chamber and a second damper housing internal cavity chamber. The piston assembly preferably includes a magneto-rheological valve with a magnetic field generator having at least a first magnetic pole, the at least first magnetic pole having a pole length Lₘ, and at least a first flow channel adjacent to the magnetic field generator, the at least first flow channel having a gap width g, wherein the ratio Lₘ/g is preferably greater than or equal to 15. The method of making a magneto-rheological damper fluid preferably includes providing a magneto-rheological damper fluid having a magneto-rheological fluid magnetic iron particles total volume percentage below 30%. The method for making a magneto-rheological damper fluid preferably includes disposing the piston assembly and the magneto-rheological damper fluid in the damper housing, wherein the magneto-rheological damper fluid having the magneto-rheological fluid magnetic iron particles total volume percentage below 30% controllably flows through the at least a first flow channel with the preferred ratio of Lₘ/g to control a motion of the piston assembly relative to the damper housing.

It is to be understood that both the foregoing summary and the following detailed description are exemplary of the invention and are intended to provide an overview or framework for understanding the nature and character of the invention as claimed.

### BRIEF DESCRIPTION OF DRAWINGS

The accompanying drawings, described below, illustrate various typical embodiments of the invention and are not to be considered limiting of the scope of the invention, for the invention may admit to other equally effective embodiments. The accompanying drawings provide a further understanding of the invention and are incorporated in and constitute a part of this specification. The figures of the drawings are not necessarily to scale, and certain features and certain views of the figures may be shown exaggerated in scale or in schematic in the interest of clarity and conciseness.

FIG. 1 is a cross-section of a magneto-rheological fluid damper device operating in flow mode and including an internal accumulator.

FIG. 2A is a cross-section of a magneto-rheological fluid damper device operating in flow mode and including an external accumulator.

FIG. 2B is an enlargement along line 2B of FIG. 2A of a portion of the magneto-rheological fluid damper device including a piston rod guide.

FIG. 2C is a cross-section of a segment of a magneto-rheological fluid damper device including a piston rod guide having an internal accumulator.

FIG. 3 is a cross-section of a segment of a magneto-rheological fluid damper device including a piston assembly having a magneto-rheological fluid valve.

FIG. 4 is a cross-section of a segment of a magneto-rheological fluid damper device including a piston assembly with a magneto-rheological fluid valve having a single flow channel.

FIG. 5 is an enlargement along line 5 of FIG. 2A of a portion of the magneto-rheological fluid damper device including a piston assembly with a magneto-rheological fluid valve having multiple flow channels.

FIG. 6 is a plot of pressure versus flow rate in a piston assembly having a magneto-rheological fluid valve with three concentric flow channels operating at a low flow rate and low pressure.

FIG. 7 is a plot of pressure versus flow rate in a piston assembly having a magneto-rheological fluid valve with three concentric flow channels operating at a flow rate greater than that of FIG. 6.

FIG. 8 is a plot of pressure versus flow rate in a piston assembly having a magneto-rheological fluid valve with three concentric flow channels operating at a flow rate greater than that of FIG. 7.

FIG. 9 is a plot of yield stress versus magnetic field strength for a piston assembly a magneto-rheological fluid valve with a large Lₘ/g.

FIG. 10 is a perspective view of a flow mode rheometer for measuring yield stress in a magneto-rheological fluid valve.

FIG. 11 is a plot of yield stress as a function of iron particle volume fraction of magneto-rheological fluid in magneto-rheological fluid valves having Lₘ/g of 25 and Lₘ/g of 50.

FIG. 12 is a plot of yield stress as a function of applied magnetic field at iron particle volume fraction in magneto-rheological fluid valves containing magneto-rheological fluid ranging from 15% to 40% in volume and Lₘ/g of 25.

FIG. 13 is a map of yield enhancement region for embodiments of the invention and existing magneto-rheological fluid damper devices.

FIG. 14 is measured and model prediction performance data for a dual-channel magneto-rheological fluid valve having Lₘ/g of 23.7.

FIG. 15 is a cross-sectional view of a three-piece flow splitter for a magneto-rheological fluid valve.

FIG. 16 is a cross-sectional view of a one-piece flow splitter of a magneto-rheological fluid valve.

FIG. 17 depicts a magneto-rheological fluid damper device operating in shear mode.

FIG. 18A is a cross-section of FIG. 18C along line 18A-18A.

FIG. 18B is a perspective view of the cross-section of FIG. 18A.

FIG. 18C is a top view of a piston assembly having a magneto-rheological fluid valve with an electromagnetic coil arranged between two flow channels.

FIG. 19A is a top view of a segment of a magneto-rheological fluid damper device including a piston assembly made of stacked magnetically permeable plates.

FIG. 19B is a cross-section of FIG. 19A along line 19B-19B.

FIG. 20A is a cross-section of a segment of a magneto-rheological fluid damper device including a piston assembly having a magneto-rheological fluid valve with a chamber for merging flow from multiple channels.

FIG. 20B is a cross-section of a segment of a magneto-rheological fluid damper device including a piston assembly having a magneto-rheological fluid valve with a chamber for merging flow from multiple channels.

FIG. 21A is a cross-section of a segment of a magneto-rheological fluid damper device operating in flow mode and including a piston assembly having double coils.

FIG. 21B is a cross-section of a segment of a magneto-rheological fluid damper device operating partially in shear mode and including a piston assembly having double coils.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

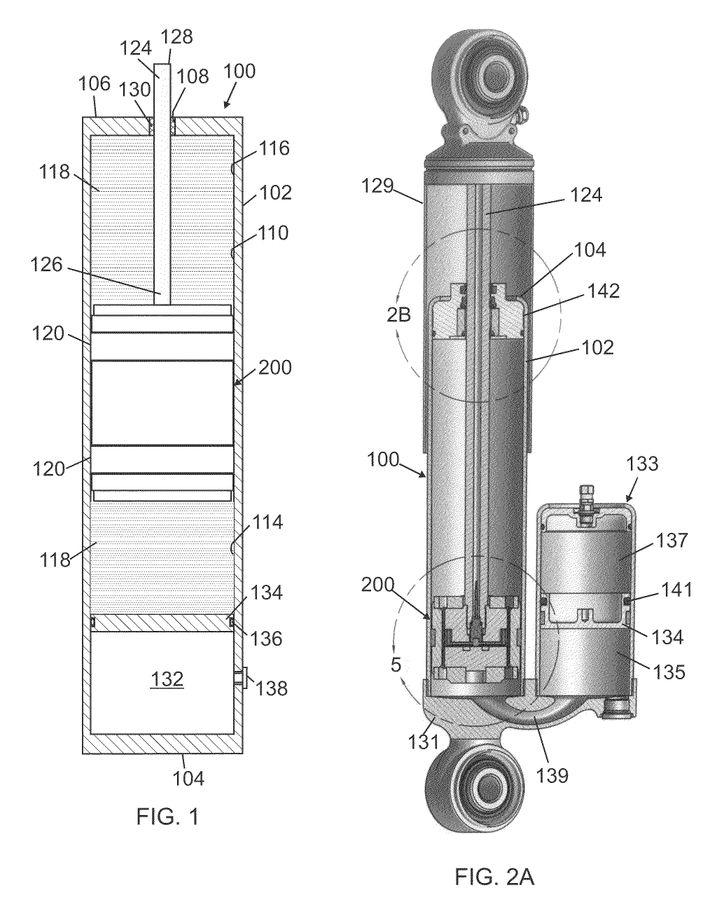

FIG. 1 schematically depicts a magneto-rheological (MR) fluid damper device 100 operating in a flow mode. The MR fluid damper device 100 includes a damper housing 102. The damper housing 102 is generally cylindrical in shape and has a first distal end 104 that is closed and a second distal end 106 that includes an aperture 108. The damper housing 102 has an internal cavity 110 in which is arranged a piston assembly 200. The piston assembly 200 subdivides the internal cavity 110 into first and second chambers 114, 116. Each of the first and second chambers 114, 116 may contain an MR fluid 118. The piston assembly 200 reciprocates along a longitudinal axis of the damper housing 102 and in response produces pressure differentials between the fluid chambers 114, 116. The pressure differentials may exist due to external stimulus forces applied between a piston rod 124 and the damper housing 102. One or more wear bands 120 made of a frictionless material may be mounted on the piston assembly 200 to support the reciprocating motion of the piston assembly 200 within the internal cavity 110. The wear bands 120 engage the interior wall of the damper housing 102 and may also provide a fluid seal between the piston assembly 200 and the damper housing 102. The piston assembly 200 includes a MR fluid valve for controlling flow of MR fluid 118 between the chambers 114, 116 in response to stimulus from the exterior of the MR fluid damper device 100. Such a stimulus may be received through the piston rod 124, which has one end 126 coupled to the piston assembly 200 and another end 128 available for coupling to structures (not shown) requiring control or damping of motion, such as a vehicle seat or chassis. The piston rod 124 extends through the aperture 108 and can slide axially relative to the damper housing 102. A seal 130 may be provided between the aperture 108 and the damper housing 102 to control leakage of fluid from the internal cavity 110.

The MR fluid damper device 100 may further include an accumulator 132 within the internal cavity 110 of the damper housing 102. Alternatively, as will be shown below, the accumulator may be located external to the damper housing 102 or integrated with a piston rod guide. The accumulator 132 may serve to minimize pressure transients in the MR fluid 118 contained within the damper housing 102, thereby minimizing the risk of cavitation or negative pressure within the damper housing 110. In the embodiment illustrated in FIG. 1, the accumulator 132 is provided as a gas charge chamber within the internal cavity 110 and adjacent to the MR fluid chamber 114. A floating piston 134 may be provided between the gas charge chamber 132 and the MR fluid chamber 114. The floating piston 134 may reciprocate axially within the internal cavity 110 in response to pressure differential between the chambers 114, 132. A seal member 136 may be mounted on the floating piston 134 to seal between the floating piston 134 and the damper housing 102, thereby preventing intermixing of the fluids in the chambers 114, 132. In alternate embodiments, a diaphragm or other suitable partition member may be used in place of the floating piston 134. The gas charge chamber 132 may be charged with gas through a fill valve 138. The charge gas may be an inert gas such as nitrogen. In alternate embodiments, other forms of accumulators, such as a bladder accumulator, may be used within the internal cavity 110 of the MR fluid damper 100.

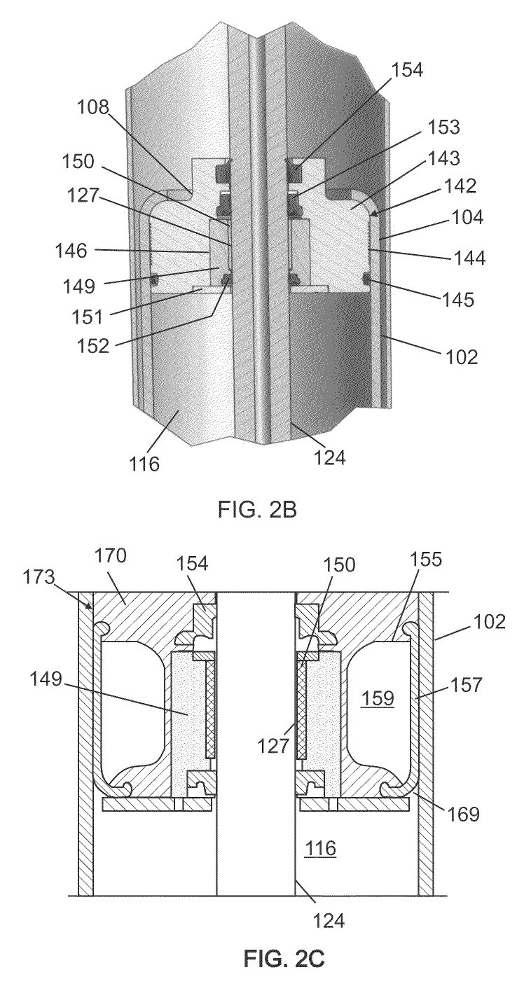

FIG. 2A shows a preferred embodiment of the MR fluid damper device 100 where an accumulator 133 is preferably located external to the damper housing 102. In this preferred embodiment, the external damper base mounted accumulator 133 includes fluid chambers 135 and 137 and a floating piston 134 disposed between the fluid chambers 135 and 137. The floating piston 134 may carry a seal member 141 to provide a seal between the floating piston 134 and the inner wall of the accumulator 133 and thereby isolate the fluid chambers 135 and 137 from each other. A damper base normal flow conduit 139 connects the fluid chamber 135 in the external damper base mounted accumulator 133 to the MR fluid chamber 114 within the damper housing 102. This external damper base mounted accumulator 133 is preferably mounted with the base 131 of the damper end, with the damper base normal flow conduit 139 providing a curved normal redirecting flow path for MR fluid through the damper end base 131, with MR fluid flowing externally outward from the damper housing 102 through the damper base normal flow conduit 139 into the external damper base mounted accumulator 133, and then flowing internally inward from the external damper base mounted accumulator 133 back inside the damper housing 102. The chamber 137 of the accumulator 133 is preferably a gas charge chamber. The external damper base mounted accumulator floating piston 134 preferably reciprocates axially within the accumulator 133 in a motion direction opposite to the motion direction of piston assembly 200 and the piston rod 124. In FIG. 2A, the distal end 104 of the damper housing 102 is received within a coupling member 129 that is connected to the piston rod 124. The coupling member 129 can be used to connect the piston rod 124 to a structure requiring control or damping of motion, as previously mentioned. In preferred embodiments the damper housing 102 does not include an accumulator in that it is internally free of an accumulator, with the damper device preferably including an external accumulator, preferably the external damper base mounted accumulator.

FIG. 2A shows a preferred embodiment of the MR fluid damper device 100 with a preferred embodiment of a piston rod guide 142. FIG. 2B is an enlargement of the preferred embodiment of piston rod guide 142. In FIG. 2B, the piston rod guide 142 is secured at the distal end 104 of the damper housing 102, the damper housing 102 receiving the piston rod guide 142 with the piston rod guide 142 including a passage 127 for receiving the piston rod 124. The piston rod guide 142 includes a guide body 143 that is secured to the damper housing 102 via any suitable method. In the embodiment shown in FIG. 2B, the fixture body 143 is secured to the inner wall of the damper housing 102 via a threaded connection 144, and a seal 145 is provided on the external surface of the fixture body 143 to seal between the fixture body 143 and the inner wall of the damper housing 102. The fixture body 143 includes an annular chamber 146 inside of which is mounted a filter 149. The filter 149 has a pocket inside of which a bearing 150 is mounted such that the bearing 150 lies between the filter 149 and piston rod 124 and thereby engages and supports reciprocal motion of the piston rod 124. The filter 149 is retained in the annular chamber 146 by an end plate 151, which has fluid flow ports through which MR fluid in the chamber 116 can reach the filter 149. A rod seal 152 is provided between the filter 149 and the piston rod 124 to seal between the filter 149 and the piston rod 124. The filter 149 strains and filters out magnetizable particles in the MR fluid 118 that enters the annular chamber 146 from the fluid chamber 116. The filter 149 is preferably made of a porous, non-magnetic, corrosion-resistant material. In a preferred embodiment, the filter 149 has a pore size less than or equal to 250 mm and is made of stainless steel. Preferably, the filter 149 is comprised of a sintered stainless steel axially extending filter member axially extending longitudinally along the piston rod 124, a seal pocket for receiving the seal 152, and a bearing pocket for receiving the bearing 150. The fixture body 143 includes a second outboard cavity in which a second outboard rod seal 153 is mounted. The rod seal 153 provides a seal between the fixture body 143 and the piston rod 124 at a location outboard above the filter 149. The fixture body 143 also includes a further outboard third cavity in which a wiper 154 is mounted. The wiper 154 wipes the piston rod 124 clean as the piston rod 124 moves in and out of the aperture 108. The rod seals 152, 153 and wiper 154 are preferably made of sealing materials such as elastomeric materials.

In a different embodiment shown in FIG. 2C, the guide body 170 of a piston rod guide 173 has been modified to include an outer cavity 155. A diaphragm 157 is mounted on the outer cavity 155 and is disposed adjacent to the inner wall of the damper housing 102 when the piston rod guide 173 is secured in place at the distal end of the damper housing 102. The diaphragm 157 and outer cavity 155 define an air volume that functions as an internal accumulator 159. The accumulator 159 may be charged with an inert gas such as nitrogen through a port (not shown) in the wall of the damper housing 102. The diaphragm 157 is exposed to the fluid in the chamber 116 through a gap 169 between the inner wall of the damper housing 102 and the exterior of the piston rod guide 173. The diaphragm 157 is depressed or expanded depending on the pressure transients in the chamber 116. The piston rod guide 173 with the accumulator 159 provides an internal accumulator adjacent the piston rod entry of the interior of an MR fluid damper device.

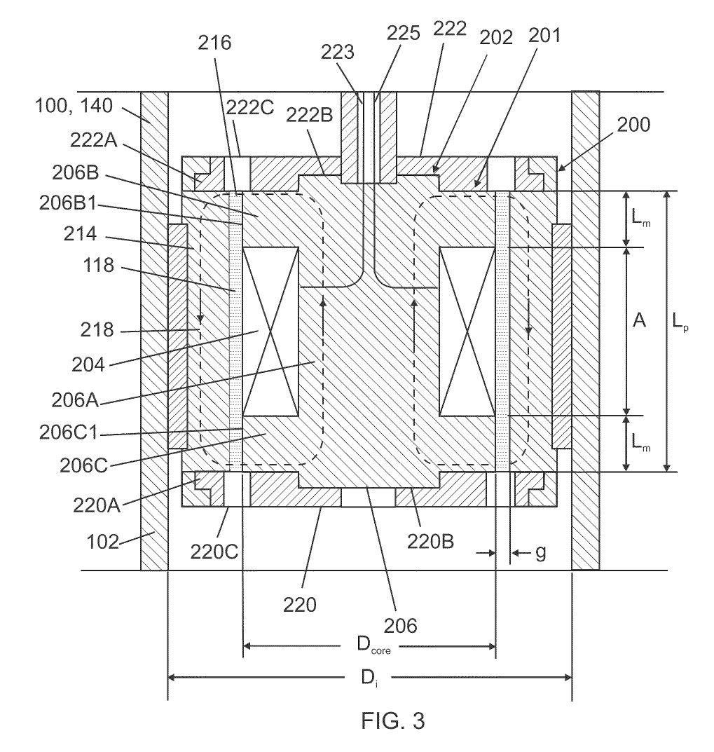

FIG. 3 schematically depicts a cross-section of an exemplary piston assembly 200 that may be included in an MR fluid damper device. The piston assembly 200 has a generally cylindrical shape. The MR fluid valve 201 provided in the piston assembly 200 includes a magnetic field generator 202. In general, the term “magnetic field generator” would be understood to mean any structure or assembly of structures providing one or more electromagnetic (EM) coils and magnetic poles adjacent to the EM coils for generating a controllable magnetic field of which the strength is controllably variable in its on-state. A “magnetic pole” is a structure carrying magnetic flux. In the embodiment of FIG. 3, the magnetic field generator 202 includes an EM coil 204 (e.g., a magnet wire) wrapped around a core 206 made of a magnetically permeable material, such as low carbon steel or other magnetically permeable ferromagnetic material. In general, some of the factors determining the characteristics of the magnetically permeable material used in the core 206 and in other components of the piston assembly 200, and variations thereof, are magnetic permeability, saturation, coercive force, and remanence. Higher values for magnetic permeability and saturation are desirable, while lower values for coercive force and remanence are desirable. Where the magnetically permeable material is used in a MR fluid damper, the relative magnetic permeability of the magnetically permeably material is preferably much larger than that of the MR fluid contained within the damper. Preferably, the relative magnetic permeability of the magnetically permeable material is at least 100 times, preferably at least 200 times, more preferably at least 1000 times larger than the magnetic permeability of the MR fluid.

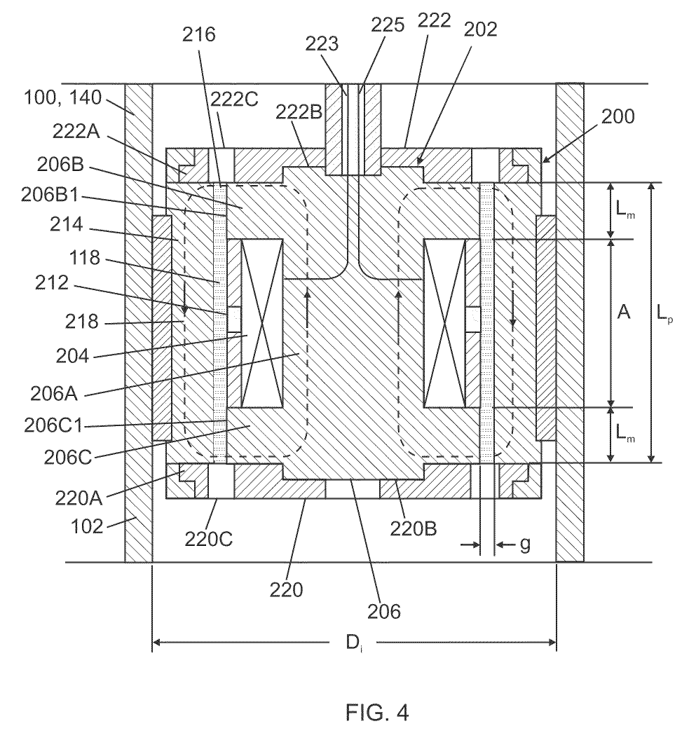

The core 206 has a central piece 206A and pole pieces 206B, 206C, which appear as flanges at the opposite ends of the central piece 206A. Each pole piece 206B, 206C provides magnetic pole of pole length Lₘ. The spacing between the pole pieces 206B, 206C is designated as pole spacing A. In some alternate embodiments, the magnetic poles may not be integrated with the core 206 and may instead be provided by other magnetically permeable structures above and below the core 206. The central piece 206A may be in the shape of a cylinder. The EM coil 204 is wrapped N times around the central piece 206A. The EM coil 204 may be wrapped on a bobbin which is disposed in a recess in the central piece 206A. The EM coil 204 is arranged between the pole pieces 206B, 206C. The core 206 may include passages (not shown) which allow external wires 223, 225 to be connected to the EM coil 204. The EM coil 204 may be arranged on the central piece 206A such that it is flush with the peripheral surfaces 206B1 and 206C1 of the pole pieces 206B, 206C. Nonmagnetic material such as epoxy may be used to secure the EM coil 204 in place on the central piece 206A. The nonmagnetic material may also fill up any spaces between the EM coil 204, thereby preventing fluid from entering in between the EM coil 204. Alternatively, as illustrated in FIG. 4, the EM coil 204 may not be flush with (and may be recessed relative to) the peripheral surfaces 206B1, 206C1 of the pole pieces 206B, 206C, respectively. A spacer 212 may be arranged adjacent to the EM coil 204 to create a magnetic discontinuity that separates the magnetic poles provided by the pole pieces 206, 206C. The spacer 212 may be made of a nonmagnetic material, such as aluminum or plastic, or a material having a very low magnetic permeability.

Returning to FIG. 3, the MR fluid valve 201 provided in the piston assembly 200 further includes a flux ring 214 surrounding the magnetic field generator 202. The cross-section of the flux ring 214 is typically circular, but other cross-sectional shapes such as square or hexagon may be used. The flux ring 214 is made of a magnetically permeable material such as described above with respect to the core 206. In a preferred embodiment, the flux ring 214 is concentric with and radially spaced from the magnetic field generator 202. The MR fluid valve 201 further includes a flow channel 216 defined between the magnetic field generator 202 and the flux ring 214. The flow channel 216 may be annular and concentric with the magnetic field generator 202. In the example shown in FIG. 3, the length of the flux ring 214 is substantially the same as the length (Lₚ) of the magnetic field generator 202. The flux ring 214 is coupled to the magnetic field generator 202, for example, using end plates 220, 222. The end plates 220, 222 include lips 220A, 222A, respectively, which engage with recesses in the flux ring 214. The end plates 220, 222 also include recesses 220B, 222B, respectively, which engage with ridges on the core 206. The end plates 220, 222 include orifices 220C, 222C, respectively, which are aligned with the flow channel 216. Preferably, any sharp edges at the orifices 220C, 222C are set-back from the flow channel 216 to avoid creating flow disturbances at the distal ends of the flow channel 216. An alternative to using end plates 220, 222 to couple the magnetic field generator 202 to the flux ring 214 is to form connecting ribs (not shown) between the distal ends of the flux ring 214 and the core 206.

When the piston assembly 200 is disposed in an MR fluid damper 100, 140, MR fluid 118 in the MR fluid damper fills the flow channel 216. The MR fluid is a non-colloidal suspension of micron-sized magnetizable particles, preferably iron particles. Current is supplied to the EM coil 214 through electrical wires 223, 225 to energize the EM coil 204 and generate a magnetic field, which is applied across the MR fluid in the flow channel 216. The magnetic flux 218 preferably moves in a path through the core 206, across the flow channel 216, preferably through the flux ring 214, across the flow channel 216, and through the core 206. The magnetic flux 218 (illustrated with dashes and arrows) is preferably perpendicular to the pole pieces 206B, 206C. When the magnetic field is applied to the flow channel 216, the apparent viscosity of the MR fluid in the flow channel 216 increases providing a controllable magnetic field on-state. The yield strength of the MR fluid in the flow channel 216 can be controlled by varying the strength of the turned on magnetic field. The MR fluid damper (100 in FIG. 1 or 140 in FIG. 2) operates in the flow mode, which means that the surfaces defining the flow channel 216 are held stationary relative to the perpendicular magnetic field and axial flow in the flow channel 216. Preferably, the surfaces of the pole pieces 206B, 206C and the flux ring 214 facing the flow channel 216 are smooth to minimize inertial and transition effects.

The flow channel 216 has a gap width g, measured along the direction in which the magnetic flux 218 flows across the flow channel 216. Preferably, the gap width g of the flow channel 216 is constant or substantially constant along the flow gap length of the flow channel 216. As will be demonstrated later, the MR fluid damper achieves enhanced on-state yield strength when Lₘ/g is large. By large, it is meant that Lₘ/g is greater than or equal to 15. More preferably, Lₘ/g is greater than or equal to 20. Most preferably, Lₘ/g greater than or equal to 25. In other preferred embodiments, Lₘ/g ranges from 20 to 50. For the piston assembly geometry depicted in FIG. 3, Lₘ/g can be made larger by increasing Lₘ or decreasing g. However, increasing Lₘ leads to an undesirably long overall piston assembly and magnetic saturation in the core 206 and flux ring 214. To avoid magnetic saturation, the diameter D_{core} of the core 206 and the thickness t_{wall} of the damper housing 102 would have to be increased. This would result in a large damper. Decreasing g rapidly leads to an unacceptably high off-state force.

A preferred approach to making Lₘ/g large without significantly increasing the size of the MR fluid damper is through the use of N flow channels with gap width gᵢ, where i ranges from 1 to N and N>1. In this case, Lₘ/gᵢ for each flow channel i would be large. For a gap width g of 0.5 mm and Lₘ/g of 25, Lₘ would be about 12.5 mm. For a system including two flow channels, having gap widths g₁, g₂, where g₁ and g₂ are 0.5 mm each, a total of 1.0 mm in total gap width would be available for fluid flow between the MR fluid chambers. For a system including a single flow channel, to achieve to gap width of 1 mm and Lₘ/g of 25, Lₘ would have to be 25 mm, i.e., twice the Lₘ required with a system including two flow channels. This example demonstrates that a compact damper having enhanced on-state yield strength can be achieved through the use of multiple flow channels. As previously discussed, the enhanced on-state yield strength is achieved by making Lₘ/g large. By large, it is meant that Lₘ/g is greater than or equal to 15. More preferably, Lₘ/g is greater than or equal to 20. Most preferably, Lₘ/g greater than or equal to 25. In other preferred embodiments, Lₘ/g ranges from 20 to 50.

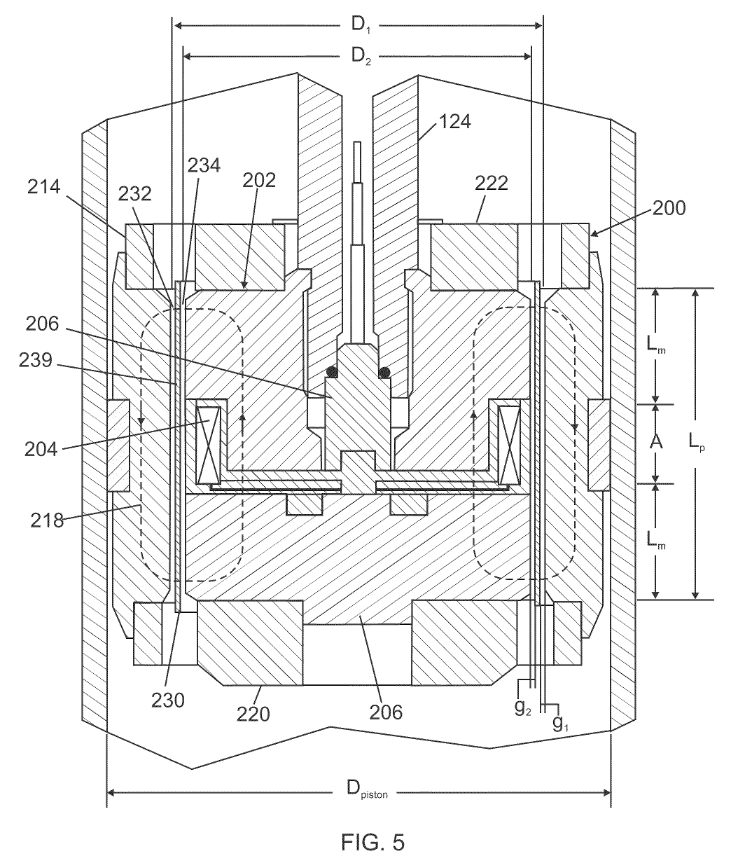

FIG. 5 shows a preferred embodiment piston assembly 200 including multiple flow channels. To form the preferred multiple flow channels, a flow splitter 230 is disposed between the magnetic field generator 202 and the flux ring 214 to define two flow channels 232, 234 between the magnetic field generator 202 and the flux ring 214. The end plates 220, 222 may include features for coupling the flow splitter 230 to the flux ring 214 and core 206 of the magnetic field generator 202. In a preferred embodiment, the flow splitter 230 is ring-shaped and concentric with the magnetic field generator 202 and the flux ring 214. This results in annular flow channels 232, 234, which are concentric with the magnetic field generator 202 and the flux ring 214. If more than two flow channels are desired, additional flow splitters can be disposed between the magnetic field generator 202 and the flux ring 214. In general, N−1 flow splitters are needed to define N flow channels, where N>0. The flow channel 232 has a gap width g₁, and the flow channel 234 has a gap width g₂. In general, each flow channel formed between the magnetic field generator 202 and the cylindrical 204 may have a gap width gᵢ, where i ranges from 1 to N, and N is the number of flow channels. The flow channels may have the same or different gap widths. For enhanced on-state yield strength, Lₘ/gᵢ is large, as described above, where i ranges from 1 to N, and N is the number of flow channels. It should be noted that Lₘ/gᵢ is calculated on a per flow channel basis.

If the piston assembly 200 includes multiple annular flow channels having equal gap widths gᵢ=g, and equal magnetic fields in the flow channels, then the pressure differential across the piston assembly 200 when arranged in the MR fluid damper would be approximately:

$$P = \frac{12 \cdot η \cdot Q \cdot {L}_{p}}{w \cdot {g}^{3}} \cdot \frac{6 \cdot c \cdot {τ}_{M R} ( H ) \cdot {L}_{m}}{g} + \frac{k \cdot {Q}^{2} \cdot ρ}{{w}^{2} \cdot {g}^{2}} \qquad ( 1 )$$

where:
η: MR fluid viscosity
Q: MR fluid volumetric flow rate (proportional to damper speed times the square of the diameter of the piston assembly)
Lₚ: length of the piston assembly
g: gap width of the flow channel
w: transverse width of the MR fluid valve and is nominally equal to

$$π {\sum }_{i = 1}^{N} {D}_{i} ,$$

where Dᵢ is the mean diameter of the i^{th} gap
τ_{MR}(H): MR fluid yield stress at a magnetic field H
Lₘ: pole length of the electromagnet
2*Lₘ: active pole length of the electromagnet
c: dynamic flow coefficient that ranges between 2 and 3
k: dynamic flow coefficient that ranges between 0 and 1.5

The constant “c” in equation (1) will depend on the specific flow conditions within the flow channels. If the flow rate in the flow channels is zero, then c would be 2. Under conditions of high flow rate, high viscosity, and very narrow gap g, then the coefficient c approaches a value of 3. The constant “k” depends primarily on Reynolds number in the flow channel, i.e., the degree of turbulence. For very high Reynolds number, k is approximately 1.0. For low Reynolds number laminar flow, k is approximately 0.68 in the off-state. When the MR fluid damper is in an on-state with a large induced yield strength, k is approximately 0.5.

In equation (1), the first term is an off-state viscous term proportional to fluid viscosity and volumetric flow rate, the second term is an added pressure due to the magnetic field induced yield strength at on-state, and the third term is an inertial term that depends on the fluid density and the square of volumetric flow rate. The viscous term is proportional to the inverse of wg³. The second term is magneto-rheological term is proportional to the inverse of g. The inertial term is proportional to the inverse of w²g². At high damper speeds, the inertial term, which has a quadratic relationship to pressure, can grow to become comparable or even exceed the off-state viscous term by a large factor. What this means is that the pressure differential (or damper force) can be quite large at off-state if the inertial term is not minimized at off-state. In the present invention, the inertial term is minimized at off-state without compromising the damper force at on-state by making Lₘ/g large and providing multiple flow channels between the electromagnet and the flux ring, where each flow channel has a small gap width. The gap width can be made as small as practical, typically about 0.5 mm, to achieve the large Lₘ/g.

In addition to making Lₘ/g large, Dₚᵢₛₜₒₙ/g may also be made large. Dₚᵢₛₜₒₙ is the diameter of the piston assembly. The significance of having Dₚᵢₛₜₒₙ/g be a large ratio has to do with fluid velocity in the flow channels and the quadratic growth of the inertial term, the third term in equation (1), at high fluid velocity. Fluid velocity in the flow channels is proportional to speed of the piston assembly times the square of the diameter Dₚᵢₛₜₒₙ of the piston assembly divided by the channel flow area w*g, where w is the transverse width of the valve provided in the piston assembly as described with respect to equation (1). By going to multiple gaps, w can be increased, which then allows g to be decreased or Dₚᵢₛₜₒₙ to be increased while still keeping the inertial term small. Decreasing g increases the on-state pressure differential, and increasing Dₚᵢₛₜₒₙ increases overall damper force, which is the product of pressure differential and piston area. Preferably, Dₚᵢₛₜₒₙ/g is greater than 66. More preferably, Dₚᵢₛₜₒₙ/g is greater than 80. Much more preferably, Dₚᵢₛₜₒₙ/g is greater than 90. Most preferably, Dₚᵢₛₜₒₙ/g is greater than 120.

If the flow channels in the piston assembly 200 are not equal and/or the magnetic field induced yield strengths in the different flow channels are not equal, then the pressure across the piston assembly will be described by the following set of equations:

$$\begin{matrix}{P}_{i} = min [ \{ \frac{12 \cdot η \cdot Q \cdot {L}_{p}}{{w}_{i} \cdot {g}_{i}^{3}} + \frac{6 \cdot c \cdot {τ}_{M R} ( {H}_{i} ) \cdot {L}_{m}}{{g}_{i}} + \frac{{k}_{i} \cdot {Q}_{i}^{2} \cdot ρ}{{w}_{i}^{2} \cdot {g}_{i}^{2}} \} , {P}_{k \neq i} ] & ( 2 ) \\ {P}_{piston} = {P}_{1} = {P}_{2} = … = {P}_{i} & ( 3 )\end{matrix}$$

The situation described in equation (2) is far more complex than the one described in equation (1) since the flow rates in the different flow channels will be different. In some cases, there may not be any flow in some of the gaps depending on the resultant Pₚᵢₛₜₒₙ. Equation (2) is itself a set of N equations, where N is the number of concentric flow channels and the subscripts i and k range from 1 to N. As an example, for i=1, equation (2) is interpreted to mean that the pressure differential due to flow channel 1 will be the minimum of the first term in curly brackets or the pressure differential in one of the other flow channels, i.e., k=2, 3, . . . , N. Note that in all cases the pressure differential in each of the gaps must ultimately be the same and equal to the pressure differential across the piston assembly as indicated by equation (3).

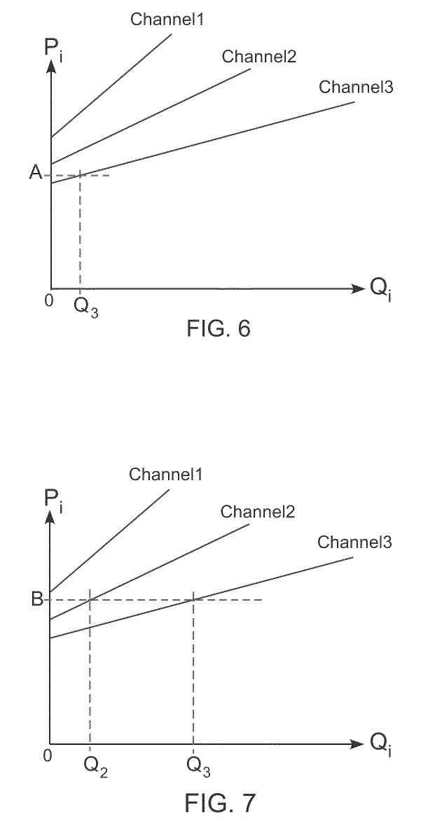

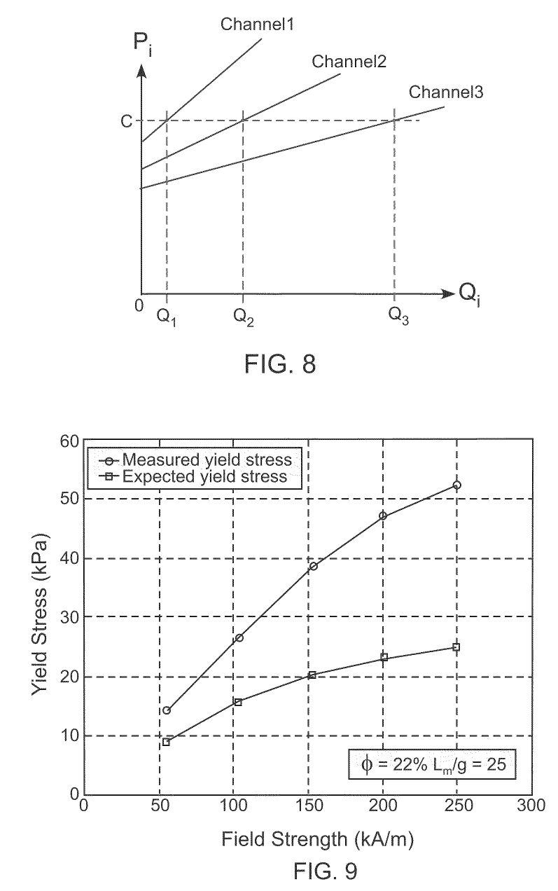

The above set of equations may be better understood with reference to FIGS. 6-8. FIG. 6 illustrates the case of three concentric flow channels at a low flow rate and low pressure. The three curves are the theoretical pressure versus flow rate for each of the three flow channels as given by the curly bracket portion of equation (2). In this case, minimum pressure drop is indicated by dashed line A. In this case, the only flow channel with a non-zero flow rate flow is Channel 3. The curves for Channels 1 and 2 are both greater than this, so the overall pressure in all channels is given by A. FIG. 7 shows what happens when the overall flow rate increases so that there is now flow in both channels 2 and 3 as given by dashed line B. There is still no flow in Channel 1. The flow rate in Channel 2 is Q₂ and that in Channel 3 is Q₃. Q₂ and Q₃ are not the same. FIG. 8 shows what happens when the overall flow increases so that there is now flow in all three channels, Q₁, Q₂, and Q₃, which are all different. In this case, the pressure is given by dashed line C.

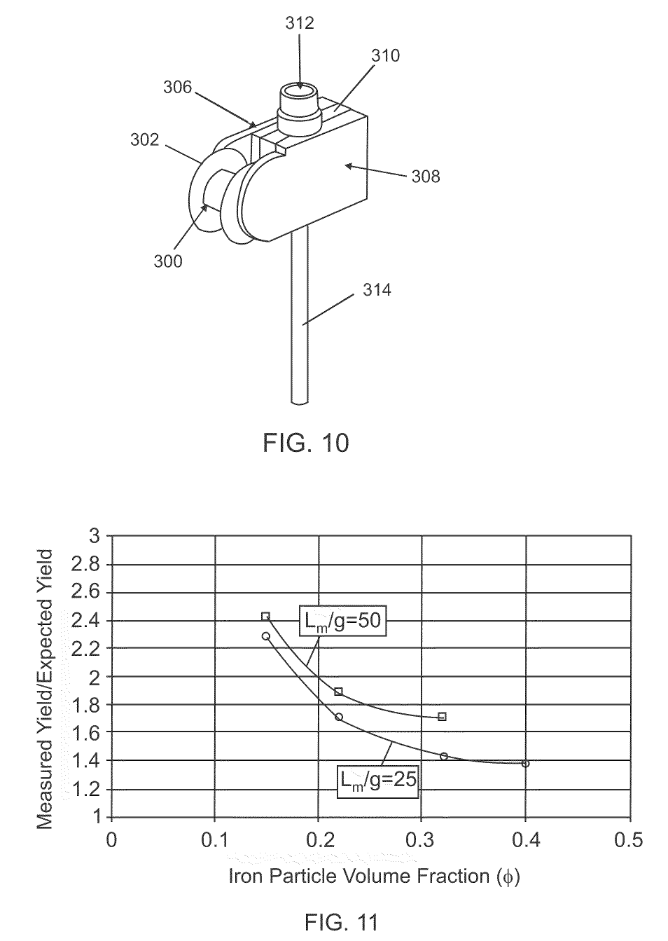

FIG. 9 is a plot of yield stress as a function of magnetic field strength. Measured and expected yield stress are shown in the plot. In this example, Lₘ/g is 25, and the MR fluid has an iron content of 22% by volume. The plot shows that the measured yield stress is more than a factor of 2 greater than the expected yield stress, indicating the enhanced yield stress phenomenon achievable by making Lₘ/g large. The measurements were made using a flow-mode rheometer. FIG. 10 shows the rheometer 300 including a plastic bobbin 302 on which an EM coil (not shown) is wound. The plastic bobbin 302 is sandwiched between pole pieces 306, 308 made of steel. The pole pieces 306, 308 are spaced apart by a nonmagnetic spacer 310 made of stainless steel. The nonmagnetic spacer 310 includes a flow channel (not shown). Inlet and outlet tubes 312, 314 are coupled to either ends of the nonmagnetic spacer 310, in alignment with the flow channel in the nonmagnetic spacer 310. The flow channel has a rectangular cross-section with a gap width g. The pole pieces 306, 308 have a pole length Lₘ. To make measurements, the rheometer 300 is placed in a metal cylinder (not shown). The rheometer 300 and metal cylinder are located in an Instron test machine (not shown) that pushes a plunger downward at a specified rate, thus forcing MR fluid through the flow channel in the spacer 310. A load cell measures the resulting force on the plunger. From this force, the pressure developed by the rheometer is calculated. The calculated pressure is used to determine the yield strength developed by the MR fluid due to the applied magnetic field.

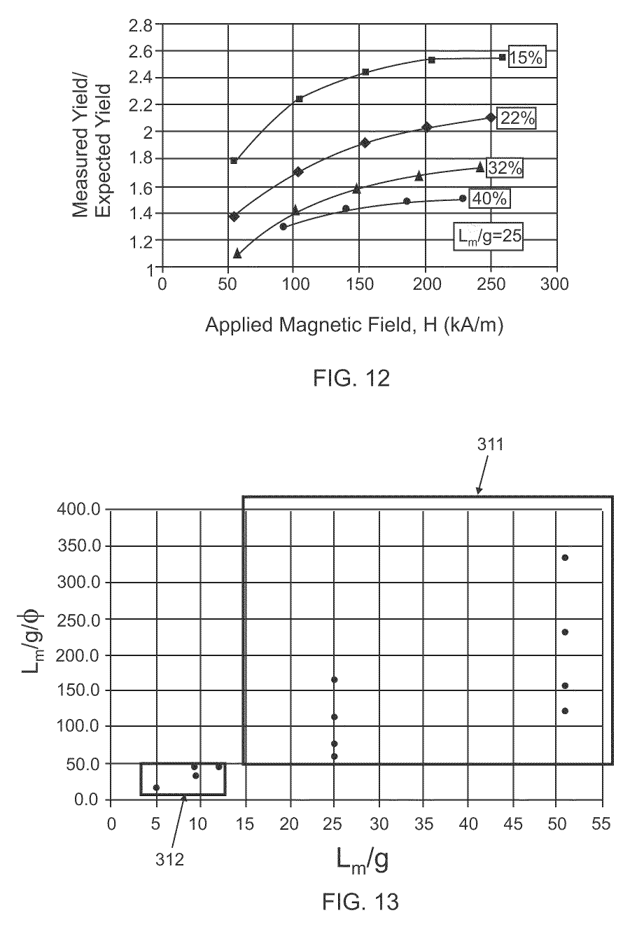

FIGS. 11 and 12 show several more examples of the enhanced yield strength phenomenon achieved by making Lₘ/g large. FIG. 11 shows yield stress versus iron particle volume fraction of MR fluid at a magnetic field strength of 100 kA/m and Lₘ/g of 25 and 50. FIG. 11 shows that the yield stress increases as iron particle volume fraction decreases. FIG. 11 also shows that yield strength increases as Lₘ/g increases. FIG. 11 shows yield stress versus applied magnetic field at Lₘ/g of 25 for various iron particle volume fractions of MR fluid. FIG. 12 also shows that yield stress increases as iron particle volume fraction decreases irrespective of the strength of the applied magnetic field. From FIGS. 11 and 12, it can be concluded that the yield enhancement that occurs when Lₘ/g is large, as described above, can be further improved by using a MR fluid having a low volume fraction of magnetizable particles, preferably iron particles.

Preferably the MR fluid contains <30 Vol. % magnetic iron particles, preferably ≦26 Vol. % magnetic iron particles, preferably <25 Vol. % magnetic iron particles, preferably <23 Vol. % magnetic iron particles, preferably <21 Vol. % magnetic iron particles, preferably ≦19 Vol. % magnetic iron particles, preferably ≦17 Vol. % magnetic iron particles, and preferably ≦16 Vol. % magnetic iron particles. Preferably the MR fluid contains about 26 Vol. % ((26±1)Vol. %) magnetic iron particles. Preferably the MR fluid contains about 15 Vol. % ((15±3)Vol. %) magnetic iron particles. Preferably the MR fluid has a magnetic iron particle volume percent range of about ten to twenty (by percent of total volume).

Preferably the MR fluid is comprised of ≦19 Vol. % magnetic iron particles (by percent of total volume) and ≧60 Vol. % carrier fluid (by percent of total volume), preferably ≧64 Vol. % carrier fluid, ≧66 Vol. % carrier fluid, ≧69 Vol. % carrier fluid and preferably about 71 Vol. % ((71±3)Vol. %) carrier fluid, preferably an oil carrier fluid, preferably a hydrocarbon oil carrier fluid. Preferably the carrier fluid is comprised of a poly-alpha-olefin.

Preferably the magnetic iron particles are comprised of iron. Preferably the magnetic iron particles are comprised of carbonyl iron particles. In an alternative preferred embodiment the magnetic iron particles are comprised of water atomized iron particles. Preferably the magnetic iron particles have a density in the range from 7 to 8.2 g/ml, preferably in the range of about 7.5 to 8.2 g/ml, and preferably a density of about 7.86 g/ml (7.86±0.30 ml).

Preferably the MR fluid includes additives in addition to the magnetic iron particles and carrier fluid. Preferably the MR fluid includes an antiwear additive. Preferably the MR fluid includes at least one antiwear additive which increases the lifetime and wear characteristics of the MR fluid device and inhibits wear related to the working of the MR fluid and abrasion and rubbing of the magnetic iron particles to the components of the MR fluid device. Preferably the MR fluid antiwear additive comprises molybdenum, preferably organomolybdenum. Preferably the MR fluid includes an antioxidant additive. Preferably the MR fluid includes at least one antioxidant additive which inhibits oxidation of the MR fluid and the MR fluid device related to the working of the MR fluid and abrasion and rubbing of the magnetic iron particles to the components of the MR fluid device. Preferably the MR fluid antioxidant additive comprises a phosphorus antioxidant additive, preferably an ashless phoshorordithioate antioxidant additive. Preferably the MR fluid includes an antisettling additive. Preferably the MR fluid includes at least one antisettling additive which provides a suspension aid to the magnetic iron particles in the carrier fluid to inhibit settling out of the particles and aid in their staying in suspension. Preferably the MR fluid antisettling additive comprises a clay, preferably an organoclay, preferably an organoclay gellant, preferably activated with an activator, preferably propylene carbonate. Preferably the MR fluid includes a MR fluid seal swelling conditioner additive. Preferably the MR fluid includes at least one MR fluid seal swelling conditioner additive which conditions seals in the MR fluid device exposed to the fluid, and preferably swells the seals and inhibits leaking of the fluid from the MR fluid device. Preferably the MR fluid seal swelling conditioner additive comprises a sebacate, preferably di-octyl sebacate.

Preferably the magnetic iron particles are dispersed in the carrier fluid, preferably with the magnetic iron particles mixed into the carrier fluid. With additives in addition to the magnetic iron particles and carrier fluid, the additives are preferably mixed into the carrier fluid. In preferred embodiments the MR fluid is rotary mixed with a rotary mixer, preferably with a rotating rotor stator mixing for mixing periods to mix and disperse the magnetic iron particles and additives in the carrier fluid.

Preferably the MR fluid with the <30 Vol. % magnetic iron particles total volume is provided by making and providing a MR fluid from ingredients based on volume percent measurements. Preferably the MR fluids are provided with the magnetic iron particles total volume percentage below 30%. Preferably a variety group of MR fluids are provided with different magnetic iron particles total volume percentages below 30%, to provide a selection group of below 30% magnetic iron particles total volume percentage MR fluids to fill the damper devices and their piston's multiple annular flow channels. Preferably at least first below 30% magnetic iron particles total volume percentage MR fluid a second different below 30% magnetic iron particles total volume percentage MR fluid are provided for selection and filling a damper device to provide at least two different damper performances for a vehicle. In a preferred embodiment the invention includes providing at least V different below 30% magnetic iron particles total volume percentage MR fluids with V>1, selecting from said at least V different below 30% magnetic iron particles total volume percentage MR fluids group a below 30% magnetic iron particles total volume percentage MR fluid that provides a preferred vehicle damper performance for an at least one flow channel with a ratio Lₘ/g greater than or equal to 15. In preferred embodiments the first and second selected below 30% magnetic iron particles total volume percentage MR fluids are 15 Vol. % magnetic iron particle MR fluid and 26 Vol. % magnetic iron particle MR fluid, such as selected for the preferred damper in FIG. 2A with the preferred multiple annular flow channels in FIG. 5. A preferred 15 Vol. % magnetic iron particle MR fluid was made from 15 Vol. % carbonyl iron particles having a density of 7.86 g/ml;10 Vol. % di-octyl sebacate having a density of 0.92 g/ml; 1.65 Vol. % organoclay gellant having a density of 1.60 g/ml; 0.48 Vol. % propylene carbonate having a density of 1.189 g/ml; 0.70 Vol. % ashless phoshorordithioate antioxidant having a density of 1.06 g/ml; 0.87 Vol. % organomolybdenum complex having a density of 1.04 g/ml; and 71.30 Vol. % poly-alpha-olefin hydrocarbon oil carrier fluid having a density of 0.81 g/ml . An initial mixture of about eighty percent of the hydrocarbon oil carrier fluid was made with the organoclay gellant and propylene carbonate and half of the organomolybdenum complex which was mixed in a rotary mixer rotor stator, then the carbonyl iron particles were mixed, and then the remainder of the ingredients was added and mixed. The resulting MR fluid with the <30 Vol. % magnetic iron particles, with the preferred 15 Vol. % magnetic iron particle level preferably had density of about 1.88 g/ml and a zero degree Celsius viscosity of about 144 cP and a twenty five degree Celsius viscosity of about 45 cP. Similarly a 26 Vol. % magnetic iron particles total volume percentage MR fluid was made from 26 Vol. % carbonyl iron particles. Similarly a 22 Vol. % magnetic iron particles total volume percentage MR fluid was made from 22 Vol. % carbonyl iron particles.

Preferably the MR fluid magnetic iron particles have an iron particle volume fraction in the range from 0.1 to 0.45, preferably from 0.1 to 0.4. Preferably the MR fluid magnetic iron particles have an iron particle volume fraction below 0.3, and preferably below 0.2.

FIG. 13 is a map defining the yield enhancement region according to preferred embodiments of the invention. The horizontal axis is the Lₘ/g ratio while the vertical axis gives Lₘ/g/φ, where φ is the iron particle volume fraction. MR fluid dampers according to the preferred embodiments of the invention fall in the large box 311. Existing MR fluid dampers having the Lₘ, g, and φ properties shown in Table 1 fall into the small box 312. All of the dampers listed in Table 1 (and falling within the small box 312 in FIG. 13) have Lₘ/g less than or equal to 13 and Lₘ/g/φ less than 50. No significant amount of yield strength enhancement is observed for the valves in the small box. The MR fluid valves according to the invention fall into the larger box. These fluid valves have Lₘ/g greater than 15 and Lₘ/g/φ greater than 50.

TABLE 1

| Damper ID | Lₘ (mm) | g (mm) | Lₘ/g | φ | Lₘ/g/φ |
|---|---|---|---|---|---|
| A | 24 | 2.0 | 12 | .40 | 27 |
| B | 16 | 1.5 | 10.7 | .40 | 24 |
| C | 6.5 | 0.7-1.3 | 5-9.3 | .22-.26 | 19-42 |
| D | 6 | 0.5 | 12 | .28 | 42 |
| E | 13 | 1.0 | 13 | .32-.35 | 37-41 |
| F | 20 | 2 | 10 | .32 | 31 |
| G | ~17 | 3 | 5.7 | .35 | 16 |
| H | 10 | 2 | 5 | .32 | 16 |
| I | 20 | 1.5 | 13 | .32 | 41 |
| J | 17 | 3 | 5.7 | .35 | 16.2 |
| K | 12 | 1.25 | 9.6 | .26 | 37 |

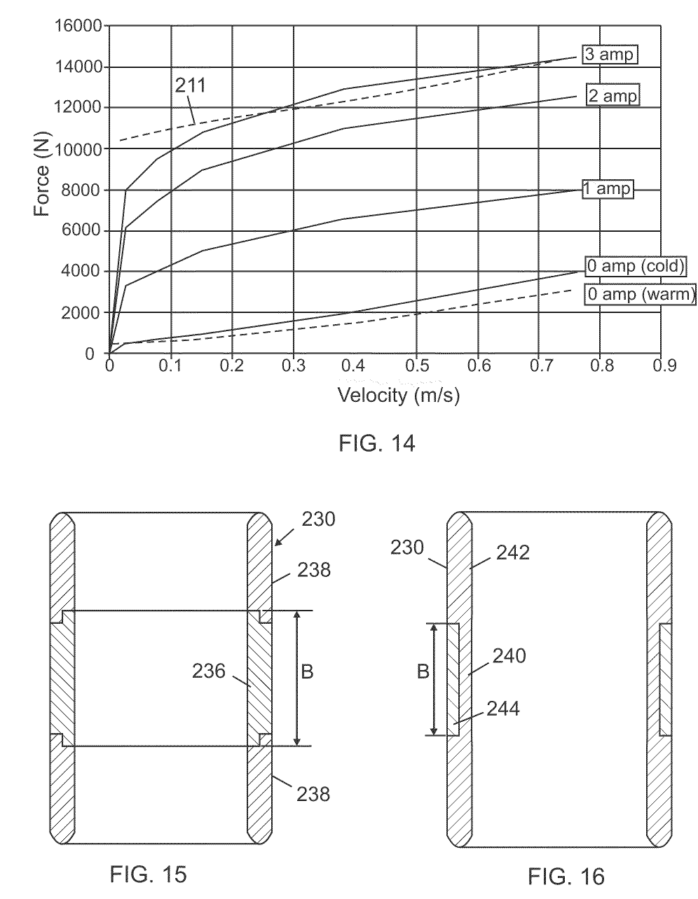

FIG. 14 shows measured performance data for a dual-channel damper having an outside diameter of 76 mm. This damper is filled with an MR fluid that contains 15% iron particles by volume. This damper had uniform gaps g of 0.5 mm and Lₘ of 11.85 mm for a resultant Lₘ/g of 23.7 mm. The measured forces for this damper are indicated by the solid lines and indicated data points. In order to achieve the observed forces at an input current of 3 amps, the fluid in this damper must exhibit a yield strength enhancement factor of 2.25. The upper dashed line 211 is the predicted performance for this damper with a 15% MR fluid exhibiting a yield enhancement factor of 2.25, i.e., the apparent yield strength of the MR fluid is more than double what would be measured with a rotary direct shear rheometer.

Returning to FIG. 5, due to flux losses in the flow splitter 230 and fringing of the magnetic field, the magnetic flux density in the flow channel 232 closest to the flux ring 214 would tend to be smaller than the magnetic flux density in the flow channel 234 farther away from the flux ring 214. Thus, the fluid in the flow channel 232 closest to the flux ring 214 will yield and flow before the fluid in the flow channel 234 farther away from the flux ring 214. Such an effect can be compensated for by making the gap width g₁ of the flow channel 232 closest to the flux ring 214 smaller than the gap width g₂ of the flow channel farther away from the flux ring 214.

The flow splitter 230 preferably saturates magnetically at high flux densities to limit the flow of magnetic flux along the axial length of the flow splitter 230. For example, as illustrated in FIG. 15, the flow splitter 230 includes a nonmagnetic portion 236 interposed between and connected to a pair of magnetically permeable portions 238. Alternatively, the flow splitter 230 can be considered as having a nonmagnetic portion 236 and a magnetically permeable portion 238, wherein the nonmagnetic portion 236 is embedded in a middle portion of the magnetically permeable portion 238 such that the nonmagnetic portion 236 is in opposing relation to the EM coil (204 in FIG. 5). The nonmagnetic portion 236 prevents flow of magnetic flux between the pair of magnetically permeable portions 238. The magnetically permeable portions 138 are preferably made of a high permeability material such as a high permeability ferromagnetic material. In another implementation, as illustrated in FIG. 5, the flow splitter 230 is a single ring made of a magnetically permeable material, such as low carbon steel, where the single ring is very thin, e.g., on the order of 1 mm in radial thickness. The middle region 239 of the thin single ring would become magnetically saturated, thereby limiting axial flow of the magnetic flux. In another embodiment, as illustrated in FIG. 16, the flow splitter 230 may be a single ring 242 made of a magnetically permeable material, such as low carbon steel, and having a thinned middle portion 240. As in the previous example, the thinned middle region 240 will become magnetically saturated quickly and limit axial flow of magnetic flux in the flow splitter 230. The thinned middle region 240 may be backfilled with a nonmagnetic material 244, such as epoxy, to provide the flow splitter 230 with a consistent radial thickness along its axial length, thereby preserving a smooth, uniform fluid flow path. Improved performance may be achieved if the single-piece flow splitter 230 is made of a ferromagnetic alloy such as HyMu80 (80% nickel and 20% iron) or other iron-nickel alloy that has a very high initial permeability but saturates at a relatively low flux density.

For cases where the middle region of the flow splitter 230 is thinned (as illustrated at 240 in FIG. 16) or includes a nonmagnetic material (as illustrated at 236 in FIG. 15), the length (B) of the thinned region or the nonmagnetic material is preferably less than the pole spacing (A in FIG. 5). Preferably, B<A−2g. More preferably, B<A−5g. Most preferably, B<A−10g. The parameter “g” is the gap width of the flow channel. For N flow channels, the parameter “g” may be defined as the average of the gap widths of multiple flow channels. In the case of flow channels (232, 234 in FIG. 5), g may be defined as (g₁+g₂)/2.

The flow splitter 230 is preferably thin in radial thickness to allow for a compact piston assembly 200 and flux ring 214 that is thick enough to avoid magnetic saturation. As an example, the flow splitter 230 may be 2 mm or less in radial thickness, and preferably 1 mm or less in radial thickness. The radial thickness of the flow splitter 230 should be significantly less than the radial thickness of the flux ring 214. This is to limit the axial flow of magnetic flux in the flow splitter 230 while allowing an easy axial flow of the magnetic flux in the flux ring 214. Preferably, the thickness of the splitter 230 is equal to or less than ½ the thickness of the flux ring 214. More preferably, the thickness of the flow splitter 230 is equal to or less than ⅓ the thickness of the flux ring 214. Most preferably, the thickness of the splitter 230 is equal to or less than ¼ the thickness of the flux ring 214.

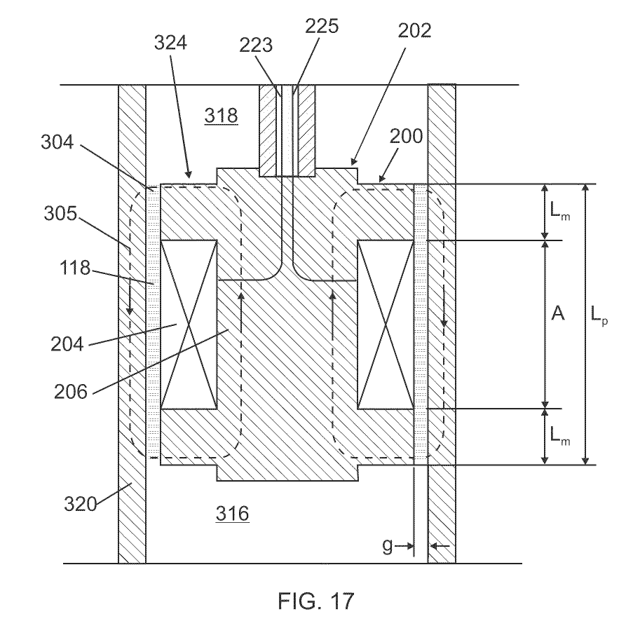

The MR fluid damper device has been described in terms of the flow channel(s) of the MR fluid valve being located within the piston assembly 200, and variations thereof. However, flow channel(s) can also be located outside of the piston assembly 200, and variations thereof. FIG. 17 shows an example of a system where a flow channel 304 of the MR fluid valve is located between a piston assembly 324 and a damper housing 320. The flow channel 304 has a gap width g. In this example, the piston assembly 320 includes the magnetic field generator 202 as previously described. As in the previous examples, Lₘ/g is large. In this example, the damper housing 320 functions as the flux ring made of a magnetically permeable material. In general, at least the portion of the damper housing 320 that would surround the magnetic field generator 202 during operation should be made of a magnetically permeable material. The magnetic field generator 202, when energized, applies a magnetic field across the MR fluid in the flow channel 304. Magnetic flux 305 moves in a single, continuous path, up the core 206 of the magnetic field generator 202, across the flow channel 304, down the damper housing 302, across the flow channel 304, and up the core 206. In this case, the MR fluid damper device operates in a shear mode, which means that one or more of the surfaces defining the flow channel 304 are not held stationary relative to the perpendicular magnetic field and axial flow in the flow channel 216. In this case, the magnetic field generator 202 moves axially relative to the damper housing 302 in response to pressure differential in the fluid chambers 306, 308.

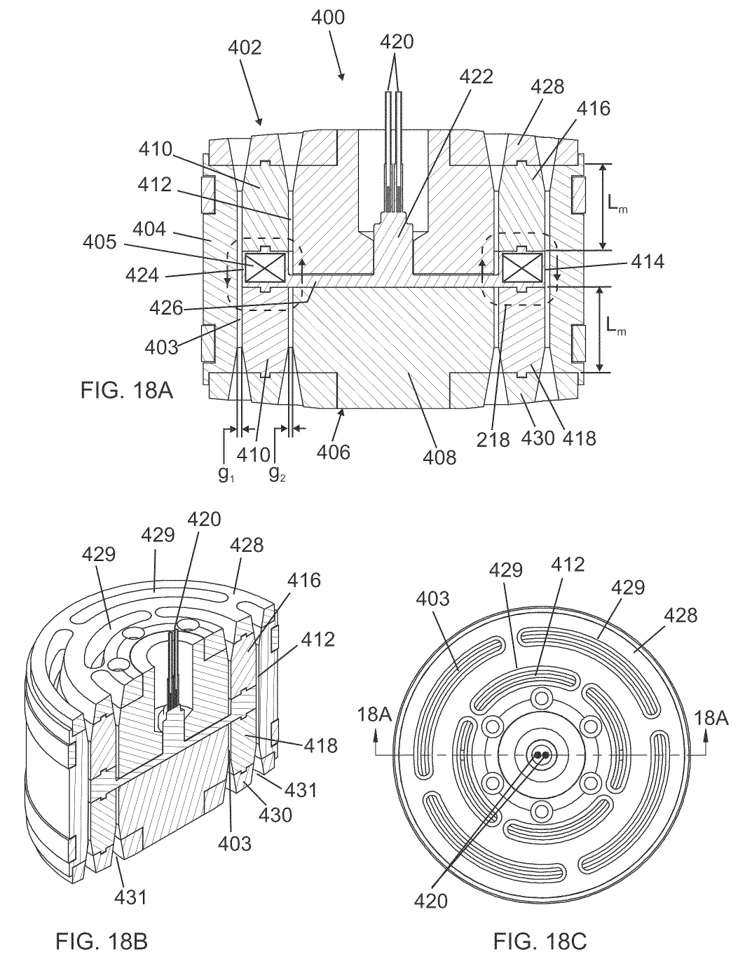

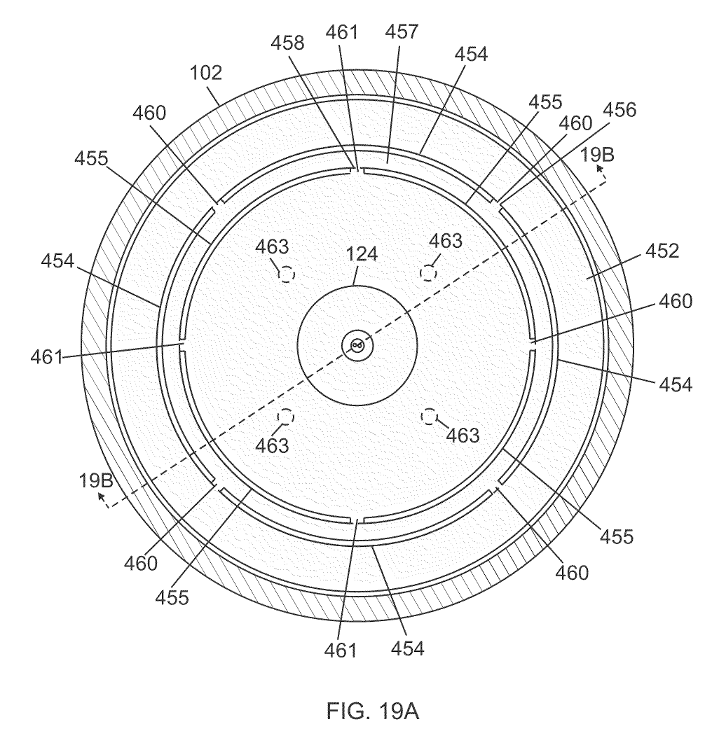

FIGS. 18A-18C show a piston assembly 400, for use with a MR fluid damper device, having a MR fluid valve with multiple annular flow channels, and a magnetic field generator 402 with EM coil 405 functioning as a flow splitter. As in previous embodiments, the piston assembly 200 has a generally cylindrical shape. In the embodiment illustrated in FIGS. 18A-18C, the magnetic field generator 402 is concentric with the flux ring 404 made of a magnetically permeable material, as previously described. The core 406 of the magnetic field generator 402 has an inner core portion 408 and an outer core portion 410, which are concentric. The outer core portion 410 includes EM coil 405 and pole pieces 416, 418. The pole pieces 416, 418 provide magnetic poles of length Lₘ. The inner core portion 408 is radially spaced from the outer core portion 410 so that a flow channel 412 is defined between the inner core portion 408 and the outer core portion 410. The flow channel 412 has a gap width g₂, and Lₘ/g₂ is large as described above. A flow channel 403 is defined between the flux ring 404 and the magnetic field generator 402. The flow channel 403 has a gap width g₁, and Lₘ/g₁ is large as described above. The gap widths g₁ and g₂ may be the same or different. Additional flow channels may be defined between the magnetic field generator 402 and the flux ring 404 as desired through the use of one or more flow splitters. Additional flow channels may also be defined between the inner core portion 408 and the outer core portion 410 through the use of one or more flow splitters. The EM coil 405 may be provided in a casing 414, which may be made of a nonmagnetic material. The EM coil 405 may be provided in a coil portion 424 of the casing 414 supported in the outer core portion 410, between the pole pieces 416, 418. The casing 414 includes a hub portion 424 which is supported in the inner core portion 408. The coil portion 424 and hub portion 424 may be connected by rib portions 426. The rib portions 424 may include conduits which allow electrical wires 420 to be inserted through the hub portion 422 and connected to the EM coil 405 in the coil portion 424. End plates 428, 430 with suitable connecting features may be used to couple the inner and outer core portions 408, 410 to the flux ring 404. The end plates 428, 430 include slots 429, 431 that are connected to the 403, 412.

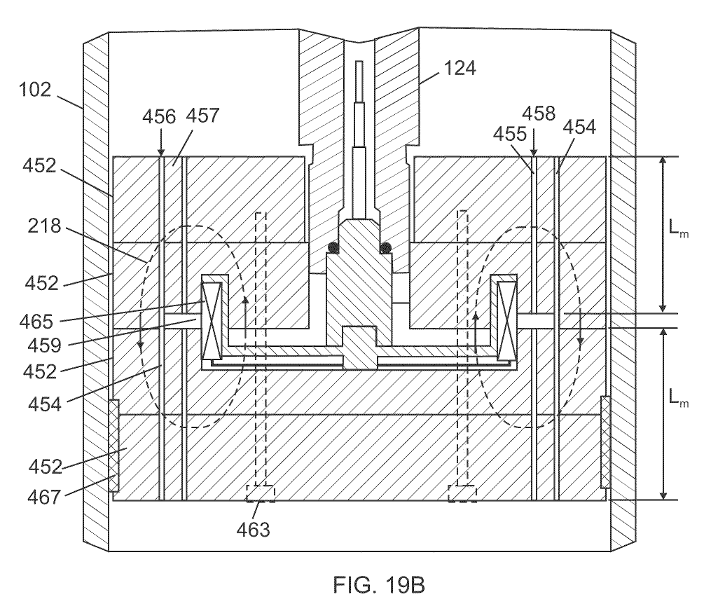

FIGS. 19A and 19B show a piston assembly 450, for use with a MR fluid damper device, made of stacked plates. The piston assembly 450 includes a stack of places 452, made of magnetically permeable material as described above. Multiple slots 454 are cut into each of the plates 452 along an outer circular path 456 using, for example, a water jet. Multiple slots 455 are also cut into each of the plates 452 along an inner circular path 458 using, for example, a water jet. The inner and outer circular paths 456, 458 are concentric. In alternate embodiments, multiple slots can be cut in the plates 452 along one circular path or along three or more circular paths, depending on the number of flow channels desired in the MR fluid valve. Each circular path represents a flow channel. Along the circular path 456, the slots 454 are separated by bridges 460. Also, along the circular path 458, the slots 455 are separated by bridges 461. The portions 457 of the plate 452 trapped between the circular paths 456, 458 function as the splitter. The splitter can be relatively thick for lateral stiffness. The slots 454, 455 provide the flow channels of the MR fluid valve. FIG. 19B shows that the intermediate plates 452 include a pocket for mounting an EM coil 465 and a surface for engaging the piston rod 124 The gap 459 between the intermediate plates (and adjacent to the EM coil 465) may be backfilled with a non-magnetic material such as epoxy. The plates 452 are held together by bolts 463. One or more of the plates 452 may be outfitted with a wear band 467 to support reciprocating motion of the piston assembly 450 within the damper housing 102. The piston assembly in FIGS. 19A and 19B preferably provides a MR damper with a multiple annular flow channel piston assembly.

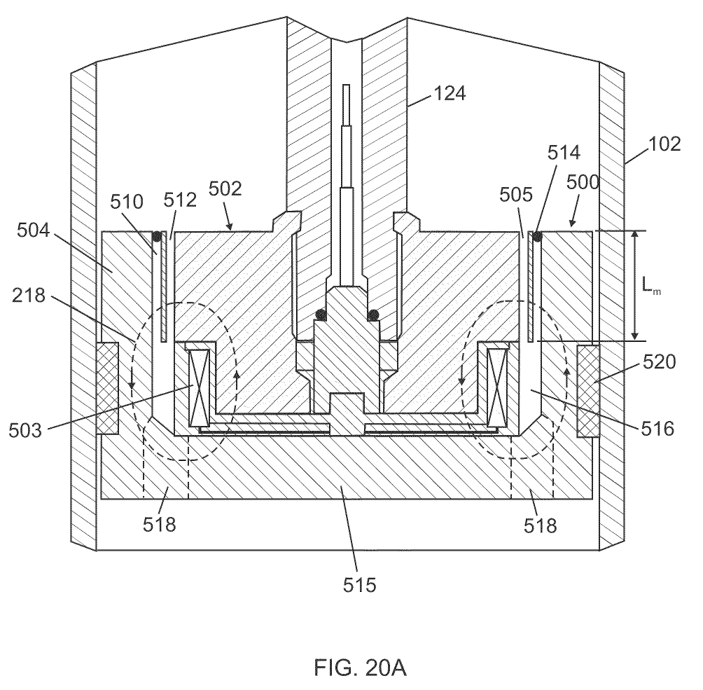

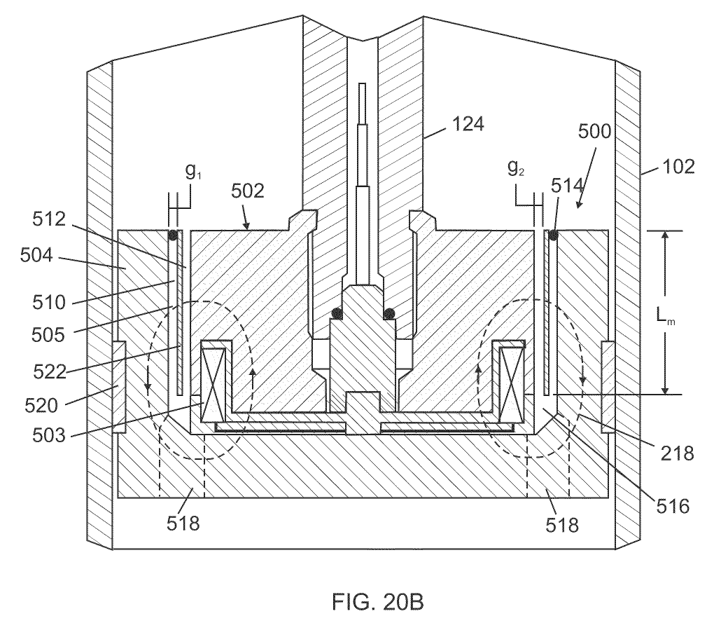

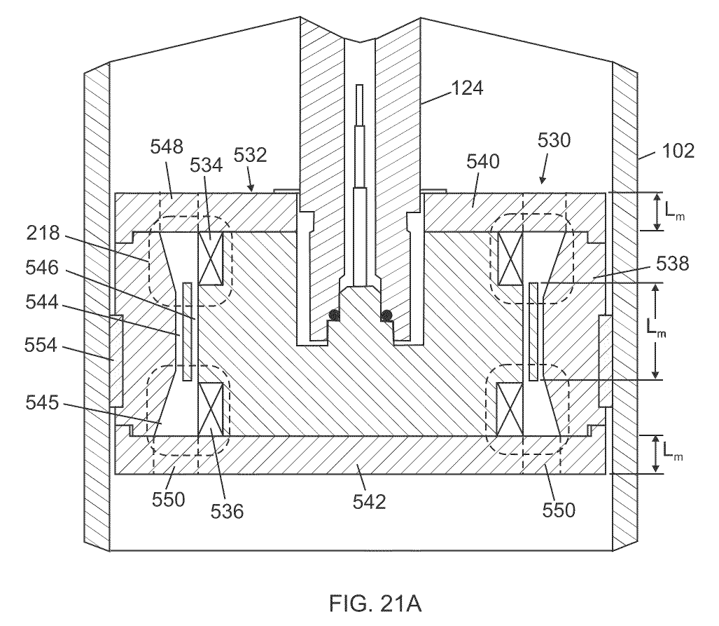

FIG. 20A shows a piston assembly 500 having a MR fluid valve with a magnetic field generator 502 including an EM coil 503. The piston assembly 500 includes a flux body 504 surrounding the magnetic field generator 502. The piston rod 124 is coupled to the magnetic field generator 502. The piston assembly 500 is disposed within the damper housing 102. A flow splitter 508 is disposed in an annular gap 505 between the flux body 504 and the magnetic field generator 502, to form concentric annular flow channels 510 and 512 in the gap. The flow splitter 508 may be held in place between the flux body 504 and the magnetic field generator 502 using one or more tacks 514. The flow splitter 508 does not extend across the entire length of the gap 505 so that a chamber 520 is formed in the gap 505 in which fluid from the flow channels 510 and 512 merge. The base 515 of the flux body 504 includes slots or holes 518 in communication with the merge chamber 516. The flux body 504 may be outfitted with a wear band 520 to support reciprocating motion of the piston assembly 500 within the damper housing 102. In FIG. 20A, the flow splitter 508 stops just above the top of the EM coil 503. FIG. 20B shows that a flow splitter 522 extending below the top of the EM coil 503 may be used in forming the annular flow channels 510 and 512. This would reduce the size of the merge chamber 516. In FIGS. 20A and 20B, additional flow splitters may be used to form more than two annular flow channels between the magnetic field generator 502 and the flux body 504.

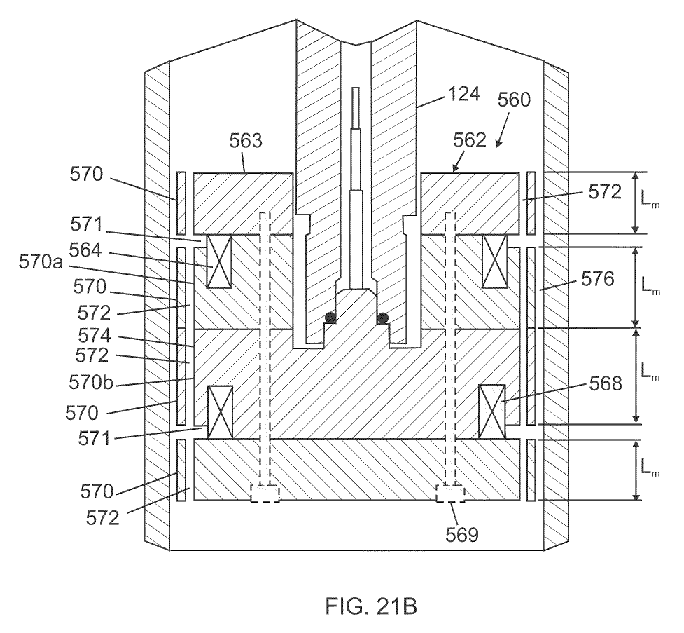

FIG. 21A shows a piston assembly 530 having a MR fluid valve with a magnetic field generator 532 including two EM coils 534 and 536. The piston rod 124 is coupled to the magnetic field generator 532. The piston assembly 530 includes a flux ring 538 surrounding the magnetic field generator 532 and magnetic pole pieces 540 and 542. A flow channel 544 is formed in a gap between the magnetic field generator 532 and the flux ring 538. A flow channel 546 is formed in the magnetic field generator 532. The flow channel 546 may be a plurality of slots cut in a plate using, for example, water jets. The flow channels 544, 546 are concentric. The magnetic pole pieces 540, 542 include holes 548, 550, respectively, that open to the flow channels 544, 546. The piston assembly 530 is disposed within a damper housing 102. The flux ring 538 may be outfitted with a wear band 554 to support reciprocating motion of the piston assembly 530 within the damper housing 102.

FIG. 21B shows a piston assembly 560 having a MR fluid valve with a magnetic field generator 562 having a core 563 made of a stack of plates 570 held together by bolts 569. The magnetic field generator 562 is coupled to the piston rod 124. The plates 570 are made of magnetically permeable material. EM coils 564 and 568 are located in pockets in the intermediate plates 570a, 570b. The recess 571 between the plates 570 (and adjacent to the EM coils 564 and 568) may be backfilled with non-magnetic material such as epoxy. The portions of the plates 570 above and below the EM coils 564, 568 act as magnetic poles. The plates 570 have slots 572, which define a flow channel 574. The piston assembly 560 is disposed within a damper housing 578. The outer diameter of the piston assembly 560 is smaller than the inner diameter of the damper housing 578 such that a flow channel 576 is formed between the inner wall of the damper housing 572 and the outer wall of the piston assembly 560. Thus, the MR fluid damper device operates partially in shear mode and partially in the flow mode in the embodiment of FIG. 21B.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A magneto-rheological fluid valve, comprising:
a magnetic field generator having at least one electromagnetic coil and at least one magnetic pole having a pole length Lₘ; and
at least one flow channel adjacent to the magnetic field generator, the at least one flow channel having a gap width g, wherein the ratio Lₘ/g is greater than or equal to 15.

2. The magneto-rheological fluid valve of claim 1, further comprising a flux ring surrounding the magnetic field generator, and wherein the at least one flow channel is defined between the flux ring and the magnetic field generator.

3. The magneto-rheological fluid valve of claim 1, wherein the gap width g is substantially constant along a flow gap length of the at least one flow channel.

4. The magneto-rheological fluid valve of claim 1, wherein the at least one flow channel is annular in shape.

5. The magneto-rheological fluid valve of claim 2, further comprising at least one additional flow channel defined between the magnetic field generator and the flux ring, the at least one additional flow channel having a gap width g₁, wherein Lₘ/g₁ is equal to or greater than 15.

6. The magneto-rheological fluid valve of claim 5, further comprising a flow splitter disposed between the magnetic field generator and the flux ring, the flow splitter defining the at least one flow channel and the at least one additional flow channel between the magnetic field generator and the flux ring.

7. The magneto-rheological fluid valve of claim 6, wherein a radial thickness of the at least one flow splitter is equal to or less than ½ of a radial thickness of the flux ring.

8. The magneto-rheological fluid valve of claim 6, wherein the at least one flow splitter comprises a nonmagnetic portion between a first magnetically permeable portion and a second magnetically permeable portion.

9. The magneto-rheological fluid valve of claim 8, wherein the magnetic field generator has at least two spaced-apart magnetic poles, and wherein an axial length of the nonmagnetic portion is less than the difference between a pole spacing between the at least two spaced-apart magnetic poles and twice the average of the gap widths, g and g₁, of the at least one flow channel and the at least one additional flow channel.

10. The magneto-rheological fluid valve of claim 6, wherein the at least one flow splitter is provided with a recess in a middle portion thereof, and further comprising a nonmagnetic material disposed in the recess.

11. The magneto-rheological fluid valve of claim 10, wherein the magnetic field generator has at least two spaced-apart magnetic poles, and wherein an axial length of the recess is less than the difference between a pole spacing between the at least two magnetic poles and twice the average of the gap widths, g and g₁, of the at least one flow channel and the at least one additional flow channel.

12. The magneto-rheological fluid valve of claim 1, wherein the magnetically permeable core comprises an inner core portion and an outer core portion in a concentric, spaced arrangement, and wherein the electromagnetic coil is included in the outer core portion.

13. The magneto-rheological fluid valve of claim 12, further comprising at least one additional flow channel defined between the inner core portion and the outer core portion, the at least one additional flow channel having a gap width g₁, wherein Lₘ/g₁ is equal to or greater than 15.

14. The magneto-rheological fluid valve of claim 13, wherein the at least one additional flow channel is concentric with the at least one flow channel.

15. The magneto-rheological fluid valve of claim 1, wherein the electromagnetic coil is offset from a surface of the magnetic field generator adjacent to the at least one flow channel.

16. The magneto-rheological fluid valve of claim 2, wherein the magnetic field generator is coupled to the flux ring.

17. The magneto-rheological fluid valve of claim 1, wherein the magnetic field generator comprises a stack of plates, each of which is made of a magnetically permeable material, and wherein the electromagnetic coil is disposed in a recess formed in at least one of the plates.

18. The magneto-rheological fluid valve of claim 17, wherein the at least one flow channel is provided by a plurality of slots formed in the plates.

19. A magneto-rheological fluid damper comprising:
a damper housing having an internal cavity for containing a magneto-rheological fluid; and
a piston assembly dividing said damper housing internal cavity into a first damper housing internal cavity chamber and a second damper housing internal cavity chamber, said piston assembly including a magneto-rheological fluid valve with
a magnetic field generator having at least a first magnetic pole, said at least first magnetic pole having a pole length Lₘ; and
at least a first flow channel adjacent to the magnetic field generator, the at least first flow channel having a gap width g, wherein the ratio Lₘ/g is greater than or equal to 15,
said damper housing internal cavity provided with a magneto-rheological damper fluid having a magneto-rheological fluid magnetic iron particles total volume percentage below 30% wherein said magneto-rheological damper fluid having a magneto-rheological fluid magnetic iron particles total volume percentage below 30% controllably flows through said at least a first flow channel with said ratio Lₘ/g to control a motion of said piston assembly relative to said damper housing.

20. The damper of claim 19, further comprising a flux ring surrounding the magnetic field generator, and wherein the at least first flow channel is between the flux ring and the magnetic field generator.

21. The damper of claim 19, wherein the gap width g is substantially constant along a length of the at least first flow channel.

22. The damper of claim 19, further comprising at least a second flow channel having a gap width g₁, wherein Lₘ/g₁ is equal to or greater than 15.

23. The damper of claim 20, further comprising at least a second flow channel between the magnetic field generator and the flux ring, the at least second flow channel having a gap width g₁, wherein Lₘ/g₁ is equal to or greater than 15.

24. The damper of claim 20, further comprising a flow splitter disposed between the magnetic field generator and the flux ring, the flow splitter defining said at least first flow channel and an at least second flow channel between the magnetic field generator and the flux ring, the at least second flow channel having a gap width g₁, wherein Lₘ/g₁ is equal to or greater than 15.

25. The damper of claim 24, wherein the magneto-rheological damper fluid has an iron volume fraction no greater than 26%.

26. The damper of claim 24, wherein the magneto-rheological damper fluid has an iron volume fraction less than 18%.

27. The damper of claim 24, wherein the magneto-rheological damper has an external accumulator.

28. The damper of claim 24, wherein the magneto-rheological damper has an external base mounted accumulator.

29. The damper of claim 24, wherein the magneto-rheological damper has an external base mounted accumulator with a damper base normal flow conduit providing a curved normal redirecting flow path through a damper end base into said external base mounted accumulator.

30. The damper of claim 19, wherein the magneto-rheological damper has an external base mounted accumulator with a damper base normal flow conduit providing a curved normal redirecting flow path through a damper end base into said external base mounted accumulator and said external base mounted accumulator includes an accumulator piston, said accumulator piston reciprocating axially within said external base mounted accumulator with a motion opposite of a motion of said piston assembly.

31. The damper of claim 30, wherein said damper includes a piston rod guide with an axially extending filter member receiving an inboard seal and a piston rod bearing.

32. The damper of claim 31, wherein said piston rod guide includes a second outboard rod seal and an outboard rod wiper.

33. The damper of claim 32, wherein said axially extending filter member filters magnetic iron particles from a magneto-rheological damper fluid with an iron volume fraction no greater than 26% and inhibits said magnetic iron particles from reaching said second outboard rod seal.

34. A magneto-rheological fluid damper, comprising:
a damper housing having an internal cavity for containing a magneto-rheological fluid; and
a piston assembly disposed within the damper housing, the piston assembly including a magneto-rheological fluid valve comprising a magnetic field generator having at least one electromagnetic coil and at least one magnetic pole having a pole length Lₘ, and at least one flow channel adjacent to the magnetic field generator, the at least one flow channel having a gap width g, wherein the ratio Lₘ/g is greater than or equal to 15.

35. The magneto-rheological fluid damper of claim 34, further comprising an accumulator defined within the damper housing.

36. The magneto-rheological fluid damper of claim 34, further comprising an accumulator that is external to the damper housing and a conduit providing communication between the external accumulator and the interior of the damper housing.

37. The magneto-rheological fluid damper of claim 34, further comprising a piston rod coupled to the piston.

38. The magneto-rheological fluid damper of claim 37, further comprising a piston rod guide disposed within the damper housing, the piston rod guide having a passage therein for receiving the piston rod.

39. The magneto-rheological fluid damper of claim 38, wherein the piston rod guide comprises a piston rod bearing assembly to engage with and support reciprocal motion of the piston rod.

40. The magneto-rheological fluid damper of claim 38, wherein the piston rod guide comprises an accumulator.

41. The magneto-rheological fluid damper of claim 38, wherein the piston rod guide is provided with a chamber and comprises a filter disposed in the chamber for filtering particulates out of magneto-rheological fluid received in the chamber from the internal cavity of the damper housing.

42. A method of making a magneto-rheological fluid damper comprising:
providing a damper housing having an internal cavity for containing a magneto-rheological fluid;
providing a piston assembly for dividing said damper housing internal cavity into a first damper housing internal cavity chamber and a second damper housing internal cavity chamber, said piston assembly including a magneto-rheological fluid valve with
a magnetic field generator having at least a first magnetic pole, said at least first magnetic pole having a pole length Lₘ; and
at least a first flow channel adjacent to the magnetic field generator, the at least first flow channel having a gap width g, wherein the ratio Lₘ/g is greater than or equal to 15,
providing a magneto-rheological damper fluid having a magneto-rheological fluid magnetic iron particles total volume percentage below 30%,
disposing said piston assembly and said magneto-rheological damper fluid in said damper housing wherein said magneto-rheological damper fluid having said magneto-rheological fluid magnetic iron particles total volume percentage below 30% controllably flows through said at least first flow channel with said ratio Lₘ/g to control a motion of said piston assembly relative to said damper housing.

43. A method as claimed in claim 42, wherein providing a magneto-rheological damper fluid having a magneto-rheological fluid magnetic iron particles total volume percentage below 30% includes selecting said magneto-rheological rheological fluid magnetic iron particles total volume percentage below 30% from a variety group of magneto-rheological damper fluids, said variety group comprised of a plurality different magneto-rheological damper fluids having different magnetic iron particle total volume fractions below 30%.

44. A method as claimed in claim 43 wherein at least a first selected damper fluid has an iron volume fraction no greater than 26%.

45. A method as claimed in claim 43 wherein at least a second selected damper fluid has an iron volume fraction no greater than 16%.

46. A method as claimed in claim 42 including terminating a first end of said damper housing with a damper end base including a curved normal redirecting flow path conduit, said curved normal redirecting flow path conduit redirecting damper fluid flow externally out into an external base mounted accumulator mounted with said damper end base.

47. A method as claimed in claim 46 with said damper base normal flow conduit providing said curved normal redirecting flow path through said damper end base into said external base mounted accumulator and said external base mounted accumulator includes an accumulator piston, said accumulator piston reciprocating axially within said external base mounted accumulator with a motion opposite of a motion of said piston assembly.

48. A method as claimed in claim 47 including terminating a second end of said damper housing with a piston rod guide with an axially extending filter member, said axially extending filter member receiving an inboard seal and a piston rod bearing.

49. A method as claimed in claim 48 wherein said piston rod guide includes a second outboard rod seal, an outboard rod wiper, and a reciprocating piston rod for reciprocating said piston assembly.

50. A method as claimed in claim 49 wherein said axially extending filter member filters magnetic iron particles from a magneto-rheological damper fluid with an iron volume fraction no greater than 26% and inhibits said magnetic iron particles from reaching said second outboard rod seal.
